(19) United States
(12) Patent Application Publication
(10) Pub. No.: US 2025/0297574 A1
(43) Pub. Date: Sep. 25, 2025

(54) FUEL SYSTEM WITH FUEL COOLED ELECTRIC GENERATION AND FUEL OIL COOLER ELIMINATION

(71) Applicant: Hamilton Sundstrand Corporation, Charlotte, NC (US)

(72) Inventors: Naison E. Mastrocola, Goshen, CT (US); Ryan P. Susca, Windsor, CT (US)

(21) Appl. No.: 18/614,159

(22) Filed: Mar. 22, 2024

(51) Int. Cl. F02C 7/22; F02C 7/232

(52) U.S. Cl. CPC F02C 7/222; F02C 7/232; F05D 2220/766; F05D 2220/768; F05D 2260/213; F05D 2260/232

(57) ABSTRACT

An aircraft fuel system includes a fuel tank, a fuel pump configured to receive a fuel flow from the fuel tank via a fuel supply line. The fuel system further includes a tap fluidly coupled to an outlet of the fuel pump, at least one generator or permanent magnet machine fluidly connected to the fuel pump via the tap, and the tap is configured to deliver fuel to the at least one generator or permanent magnet machine. The fuel system further includes a gearbox mechanically connected to the at least one generator or permanent magnet machine.

### BACKGROUND

The present disclosure relates generally to a fuel system, and more particularly to an aircraft fuel system.

Aircraft fuel systems can include multiple heat transfer interfaces, including a fuel engine oil cooler. Additionally, aircraft electrical generators and/or permanent magnet machines are traditionally cooled using oil-based coolers. Oil-based coolers help lower localized hot spot induced coking but add an additional heat transfer interface which increases cost and weight of aircrafts. As such, alternative means for lowering temperature and providing adequate lubrication to electrical generators or permanent magnet machines are desirable.

### SUMMARY

An aircraft fuel system includes a fuel tank, a fuel pump configured to receive a fuel flow from the fuel tank via a fuel supply line, a tap fluidly coupled to an outlet of the fuel pump, at least one generator or permanent magnet machine fluidly connected to the fuel pump via the tap, the tap configured to deliver fuel to the at least one generator or permanent magnet machine, and a gearbox mechanically connected to the at least one generator or permanent magnet machine.

A method of cooling and lubricating engine components includes drawing, with a fuel pump, a fuel flow from a fuel tank through a fuel supply line, providing the fuel flow through the fuel pump, providing a first portion of the fuel flow to a metering valve, providing a second portion of the fuel flow through a tap, dividing the second portion of the fuel flow into a first stream provided to a heat exchanger and a second stream provided to a generator or permanent magnet machine, warming the fuel supply line with the second stream, and returning the second portion of the fuel flow to the fuel supply line.

### BRIEF DESCRIPTION OF THE DRAWINGS

FIG. 1 is a schematic illustration of an aircraft fuel system with aircraft fuel used to cool and lubricate electrical generators according to a first embodiment.

FIG. 2 is a schematic illustration of an aircraft fuel system according to a second embodiment.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

This disclosure presents fuel systems with fuel routed to and directly cooling electrical generators or permanent magnet machines. More specifically, one or more cooling/lubricating lines are diverted downstream of the main fuel pump to one or more electrical generators or permanent magnet machines, before the fuel is returned to the fuel supply line or the heat exchanger outlet.

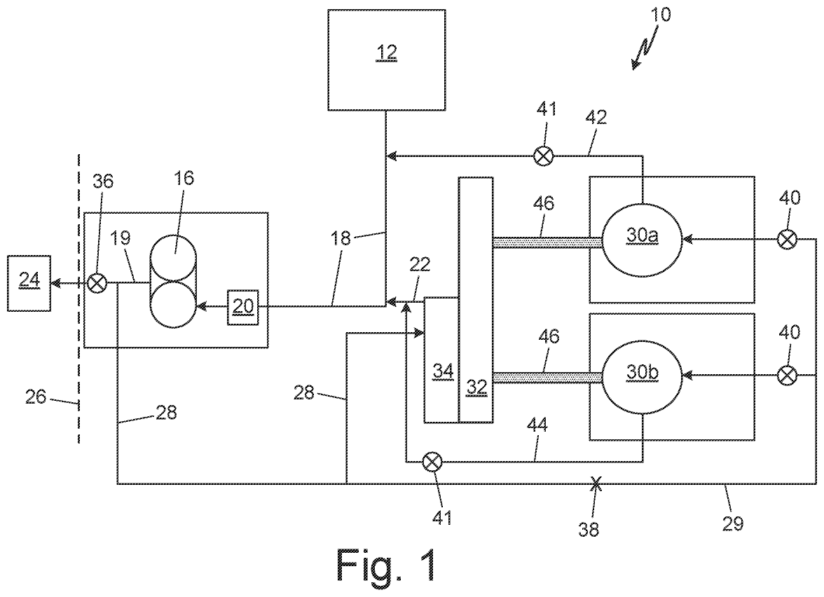

FIG. 1 is a schematic illustration of a portion of fuel system 10 for an aircraft. FIG. 1 shows fuel tank 12, main fuel pump 16, fuel supply lines 18 and 19, filter 20, component(s) 24, engine 26, tap 28, generator inlet 29, generators 30a and 30b, gearbox 32, heat exchanger 34, metering valve 36, restriction orifice 38, check valves 40 and 41, first generator outlet line 42, second generator outlet line 44, and drive shafts 46.

Fuel tank 12 can be located within a fuselage or wing of an aircraft. Main fuel pump 16 is fluidly connected to fuel tank 12 via fuel supply line 18. Filter 20 can be disposed in fuel supply line 18 upstream of main fuel pump 16. Fuel supply 19 fluidly connects main fuel pump 16 to component(s) 24 of engine 16. Metering valve 36 is disposed in fuel supply line 19 to control fuel flow from main fuel pump 16 to component(s) 24. Tap 28 fluidly connects main fuel pump 16 to generators 30a, 30b and heat exchanger 34. Tap 28 diverts a portion of fuel in fuel line 19 before metering valve 36. Check valve(s) 40 can be placed along tap 28 upstream of generators 30a, 30b to prevent backflow. Restriction orifice 38 is disposed in tap 28 downstream of where tap 28 branches to heat exchanger 28 to control flow to generators 30a, 30b through generator inlet 29. First fuel generator outlet line 42 and second fluid outlet line 44 can be fluidly connected to supply fuel line 18 to deliver fuel from generators 30a and 30b to fuel supply line 18. Second fuel generator outlet line 44 can be fluidly connected to heat exchanger outlet 22, which can be fluidly connected to fuel supply line 18. Check valve(s) 41 may be included on first generator outlet line 42 and/or second generator outlet line 44. Drive shafts 46 mechanically connect generators 30a, 30b to gearbox 32.

Filter 20 can be configured to provide filtered fuel to component(s) 24 of engine 26. Component(s) 24 can include, for example, combustor nozzles. Main fuel pump 16 can be a positive displacement pump, such as a gear pump, in an exemplary embodiment. Generators 30a, 30b can be integrated direct drive generators in an exemplary embodiment. Heat exchanger 34 is configured to transfer heat to fuel in fuel system 10. As schematically represented in FIG. 1, main fuel pump 16, filter 20, gearbox 32, and heat exchanger 34 can be mechanically coupled to engine 26.

In operation of fuel system 10, fuel can be drawn from fuel tank 12 by main fuel pump 16 along fuel supply line 18. Filter 20 can be disposed along fuel supply line 18 upstream of main fuel pump 16 to filter fuel being delivered to component(s) 24 through metering valve 36. Metering valve 36 can control fuel flow from main fuel pump 16 to component(s) 24. Tap 28 can be disposed upstream of metering valve 36 to divert a portion of fuel exiting main fuel pump 16 to generators 30a, 30b. Tap 28 can be either between filter 20 and main fuel pump 16 or before filter 20 to draw unfiltered fuel. Using a single generator instead of multiple generators is also contemplated. Restriction orifice 38 can be placed along tap 28 upstream of generators 30a, 30b to regulate fuel flow. Check valve(s) 40 can be placed along tap upstream of generators 30a, 30b to prevent backflow. Fuel that has circulated through generator 30a can be returned to fuel supply line 18 via first generator outlet line 42. Check valve(s) 41 can be included on first generator outlet line 42. Fuel that has circulated through generator 30b can be returned to fuel supply line 18 via second generator outlet line 44. Second generator outlet line 44 can route fuel to heat exchanger outlet 22, which can be fluidly connected to fuel supply line 18. Fuel flowing through tap 28 can be relatively cooler than fuel flowing through first generator outlet line 42 and second generator outlet line 44, as heat from generators 30a, 30b can be rejected to the fuel. Drive shafts 46 mechanically link generators 30a, 30b to gearbox 32. It is also possible for drive shafts 46 mechanically coupled to generators 30a, 30b and gearbox 32 to mechanically drive main fuel pump 16.

Tap 28 can be appropriately sized to ensure that generators 30a, 30b have ample fuel flowing through to adequately cool generators 30a, 30b even at high heat loads. Restriction orifice 38 can be sized to provide adequate cooling/lubrication to generators 30a, 30b and adequate fuel flow to component(s) 24.

Fuel returned to fuel supply line 18 via first generator outlet line 42 and second generator outlet line 44 effectively raises the temperature of fuel in fuel system 10. Prewarming fuel in this manner allows heat exchanger 34 to require less heat from outside fuel system 10.

In other embodiments, fuel system 10 can include a single generator 30a or 30b with a single generator outlet line 42 or 44 configured to return fuel to fuel supply line 18 downstream of heat exchanger outlet 22 or at another location of fuel supply line 18.

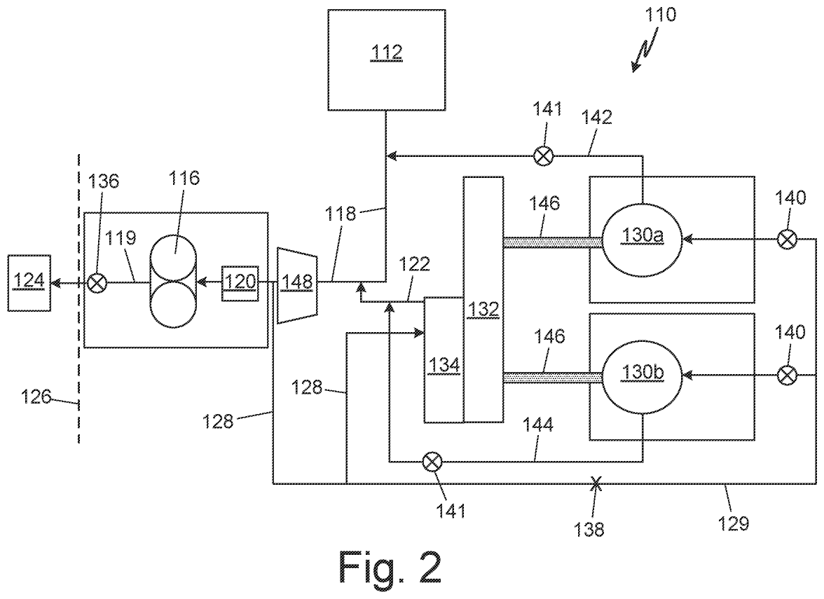

FIG. 2 is a schematic illustration of a portion of fuel system 110. Fuel system 110 is substantially similar to fuel system 10 with the addition of booster pump 148 and replacement of generators 30a and 30b with permanent magnet machines 130a and 130b. FIG. 2 shows fuel tank 112, main fuel pump 116, fuel supply lines 118 and 119, filter 120, booster pump outlet 121, heat exchanger outlet 122, component(s) 124, engine 126, tap 128, permanent magnet machine inlet 129, permanent magnet machines 130a and 130b, gearbox 132, heat exchanger 134, metering valve 136, check valves 140 and 141, first permanent magnet machine outlet line 142, second permanent magnet machine outlet line 144, drive shafts 146, and booster pump 148.

More specifically, fuel system 110 includes along the fuel flow pathway at least one fuel tank 112, booster pump 148, main fuel pump 116, heat exchanger 134, first permanent magnet machine outlet 142, and second permanent magnet machine outlet 144 for providing the flow of fuel to component(s) 124 within engine 126. Heat exchanger 134 can be a fuel engine oil cooler in an exemplary embodiment. Fuel system 110 can include filter 120 for filtering the flow of fuel provided to component(s) 124 of engine 126 which can be, in one example, combustor nozzles. Fuel system can include metering valve 136 for regulating the flow of fuel from main fuel pump 116 to component(s) 124.

Unlike fuel system 10, booster pump 148 draws fuel from fuel tank 112 along fuel supply line 118 before main fuel pump 116 and filter 120. Tap 128 is downstream of booster pump 148 and upstream of main fuel pump 116 and filter 120. Main fuel pump 116 can be a positive displacement pump, such as a gear pump, in an exemplary embodiment, and booster pump 148 can be a centrifugal pump.

Booster pump 148 is configured to receive fuel from fuel tank 112 via fuel supply line 118. Main fuel pump 116 receives fuel from booster pump 148 via booster pump outlet 121. Tap 128 can be fluidly connected to booster pump outlet 121. Tap 128 is configured to deliver fuel to heat exchanger 134 and permanent magnet machines 130a and 130b. Tap 128 can be branched to deliver a portion of fuel to heat exchanger 134 and a portion of fuel to permanent magnet machines 130a and 130b. Restriction orifice 138 can be disposed in tap 128 downstream where tap 128 branches to heat exchanger 128 to control fuel flow to permanent magnet machines 130a, 130b through permanent magnet machine inlet 129. Permanent magnet machines 130a and 130b can be fluidly connected to fuel supply line 118 via first permanent magnet machine outlet 142 and second permanent magnet machine outlet 144 to return fuel to fuel supply line 118. Second permanent magnet machine outlet 144 can be fluidly connected to heat exchanger outlet 122 which connects to fluid supply line 118. Permanent magnet machines 130a and 130b can be mechanically connected to gearbox 132 via drive shafts 146. Drive shafts can also mechanically connect gearbox 132 to booster pump 148 and/or main fuel pump 116. Fuel received from permanent magnet machines 130a and 130b can be received by booster pump 148. A portion of fuel can be drawn through tap 128 as described above. The majority of fuel exiting booster pump 148 can be drawn through filter 120 via main fuel pump 118 and delivered to component(s) 124 via fluid supply line 119.

In operation of fuel system 110, fuel can be drawn from fuel tank 112 by booster pump 148 along fuel supply line 118. Filter 120 can be disposed along fuel supply line 118 upstream of main fuel pump 116 to filter fuel flowing to component(s) 124. Metering valve 136 can control fuel flow from main fuel pump 116 to component(s) 124. Once fuel passes through booster pump 148, tap 128 diverts a portion of fuel before main fuel pump 116. Unlike fuel system 10, fuel system 110 can include permanent magnet machines 130a, 130b. Permanent magnet machines 130a, 130b can be either permanent magnet alternators (PMAs) or permanent magnet generators (PMGs). Similar to fuel system 10, an amount of the fuel flow can be diverted along tap 128 to cool and lubricate permanent magnet machines 130a, 130b. Restriction orifice 138 can be placed along tap 128 after tap 128 branches to heat exchanger 134, and also upstream of permanent magnet machines 130a, 130b to regulate fuel flow to permanent magnet machines 130a, 130b. It is also possible to replace permanent magnet machines 130a, 130b with generators 30a, 30b in fuel system 110 with booster pump 148 and vice versa, with permanent magnet machines 130a, 130b in embodiment 1 as shown in FIG. 1.

Check valve(s) 140 can be placed along tap upstream of permanent magnet machines 130a, 130b to prevent backflow. Mechanical energy from permanent magnet machines 130a, 130b can link gearbox 132 to permanent magnet machines 130a, 130b via drive shafts 146. It is also possible to mechanically couple drive shafts from gearbox 32 to booster pump 148 and/or main fuel pump 116. Fuel that has circulated through permanent magnet machine 130a can be returned to fuel supply line 118 via first permanent magnet machine outlet line 142. Check valve(s) 141 can be included on first permanent magnet machine outlet line 142. Fuel that has circulated through permanent magnet machine 130b can be returned to fuel supply line 118 via second permanent magnet machine outlet 144. Second permanent magnet machine 144 can be fluidly connected to heat exchanger outlet 122, which can be fluidly connected to fuel supply line 118. Fuel flowing through tap 128 can be relatively cooler than fuel flowing through first permanent magnet machine outlet line 142 and/or second permanent magnet machine outlet line 144, as heat from permanent magnet machines 130a, 130b can be rejected to the fuel.

The majority of fuel flow from booster pump 148 can be delivered to main fuel pump 116 through heat exchanger 134, and will not flow to permanent magnet machines 130a, 130b.

Booster pump 148 can be controlled, for example, by an electronic engine controller (EEC) or other type of controller. Various sensors (e.g., pressure and temperature sensors) can be in communication with booster pump 148 and/or main fuel pump 116 in some embodiments to provide feedback to the controller. This can include increasing booster pump 148 output to increased cooling flow to permanent magnet machines 130a, 130b based on cooling and/or lubrication needs.

Fuel systems 10, 110 with taps 28, 128 to cool generators 30a, 30b or permanent magnet machines 130a, 130b have several advantages over legacy systems. The use of an amount of tapped fuel flow for cooling and lubrication of generators/machines 30a, 30b, 130a, 130b meets operational requirements and allows for the reduction in size and/or elimination of dedicated oil systems to cool and lubricate generators/machines 30a, 30b, 130a, 130b which can reduce both cost and weight of fuel systems 10, 110. It also allows fuel systems 10, 110 to demand less external heat in heat exchangers 36, 136. Fuel returned to fuel supply line 118 via first permanent magnet machine outlet line 142 and second permanent magnet machine outlet line 144 effectively raises the temperature of all fuel entering fuel system 110. Prewarming in this manner allows heat exchanger 134 to require less heat from outside fuel system 110. Majority of fuel flowing through tap 128 will flow through heat exchanger 134 and not restriction orifice 138.

It should be understood that various other embodiments of fuel systems 10, 110 are possible. For example, fuel systems 10, 110 can include other features (e.g., valves, pumps, controllers, etc.) not shown in the figures. The disclosed fuel systems can be implemented in engines used in both military and commercial aircraft.

### Discussion of Possible Embodiments

The following are non-exclusive descriptions of possible embodiments of the present invention.

An aircraft fuel system includes a fuel tank, a fuel pump configured to receive a fuel flow from the fuel tank via a fuel supply line, a tap fluidly coupled to an outlet of the fuel pump, a first generator or permanent magnet machine fluidly connected to the fuel pump via the tap, the tap configured to deliver fuel to the first generator or permanent magnet machine, and a gearbox mechanically connected to the at least one generator or permanent magnet machine.

The fuel system of the preceding paragraph can optionally include, additionally and/or alternatively, any one or more of the following features, configurations and/or additional components:

In the above fuel system, the generator can be a direct drive generator.

In any of the above fuel systems, the fuel pump can be a main fuel pump and can be a positive displacement pump, and any of the above fuel systems can include a filter disposed upstream of the fuel pump for filtering the fuel flow.

In any of the above fuel systems, the tap can include a check valve.

Any of the above fuel systems can further include a first outlet line fluidly connected downstream of the first generator or permanent magnet machine. The first outlet line can return fuel to the fuel supply line upstream of the fuel pump.

The fuel system of the preceding paragraph can further include a check valve along the first outlet line.

Any of the above fuel systems can further include a heat exchanger disposed in fluid connection between the tap and the fuel pump. The heat exchanger can include a heat exchanger outlet fluidly connected to the fuel supply line upstream of the fuel pump.

Any of the above fuel systems can further include a second generator or permanent magnet machine, and can further include a second outlet line fluidly connecting the second generator or permanent magnet machine and the heat exchanger outlet.

The fuel system of the preceding paragraph can further include a check valve along the second outlet line.

Any of the above fuel systems can further include a metering valve downstream of the fuel pump.

Any of the above fuel systems fuel systems can further include a restriction orifice disposed along the tap upstream of the first or second generator or permanent magnet machine.

In any of the above fuel systems, the fuel pump can be a booster pump.

In any of the above fuel systems can further include a main booster pump, the fuel pump can be a booster pump, and a main fuel pump can receive fuel from the booster pump.

In the fuel system of the preceding paragraph, a tap can be fluidly connected to an outlet of the booster pump and upstream of the main fuel pump.

The fuel systems of either of the 2 preceding paragraphs can further include a filter disposed upstream of the main fuel pump and downstream of the booster pump for filtering the fuel flow.

Any of the above fuel systems can include a restriction orifice disposed along the tap upstream of the first generator or permanent magnet machine.

In any of the above fuel systems, the first permanent magnet machine can be a permanent magnet alternator.

In any of the above fuel systems, the first permanent magnet machine can be a permanent magnet generator.

A method of cooling and lubricating engine components includes drawing, with a fuel pump, a fuel flow from a fuel tank through a fuel supply line, providing the fuel flow through the fuel pump, providing a first portion of the fuel flow to a metering valve, providing a second portion of the fuel flow through a tap, dividing the second portion of the fuel flow into a first stream provided to a heat exchanger and a second stream provided to a generator or permanent magnet machine, warming the fuel supply line with the second stream, and returning the second portion of the fuel flow to the fuel supply line.

The method of the preceding paragraph can further include filtering the fuel flow with a filter before the fuel flow enters the fuel pump.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An aircraft fuel system comprising:
a fuel tank;
a fuel pump configured to receive a fuel flow from the fuel tank via a fuel supply line;
a tap fluidly coupled to an outlet of the fuel pump;
a first generator or permanent magnet machine fluidly connected to the fuel pump via the tap, the tap configured to deliver fuel to the first generator or permanent magnet machine; and
a gearbox mechanically connected to the first generator or permanent magnet machine.

2. The fuel system of claim 1, wherein the first generator is a direct drive generator.

3. The fuel system of claim 1 wherein the fuel pump is a main fuel pump and is a positive displacement pump, and wherein the fuel system further comprises a filter disposed upstream of the fuel pump for filtering the fuel flow.

4. The fuel system of claim 1 and further comprising a check valve disposed along the tap.

5. The fuel system of claim 1 and further comprising a first outlet line fluidly connected downstream of the first generator or permanent magnet machine, the first outlet line returning fuel to the fuel supply line upstream of the fuel pump.

6. The fuel system of claim 5 and further comprising a check valve disposed along the first outlet line.

7. The fuel system of claim 5 and further comprising a heat exchanger disposed in fluid connection between the tap and the fuel pump, the heat exchanger having a heat exchanger outlet fluidly connected to the fuel supply line upstream of the fuel pump.

8. The fuel system of claim 7, wherein the fuel system further comprises:
a second generator or permanent magnet machine; and
a second outlet line fluidly connecting the second generator or permanent magnet machine to the heat exchanger outlet.

9. The fuel system of claim 8 and further comprising a check valve disposed along the second outlet line.

10. The fuel system of claim 1 and further comprising a metering valve downstream of the fuel pump.

11. The fuel system of claim 1 and further comprising a restriction orifice disposed along the tap upstream of at least one generator or permanent magnet machine.

12. The fuel system of claim 1 wherein the fuel pump is a booster pump.

13. The fuel system of claim 12 and further comprising a main fuel pump configured to receive fuel from the booster pump.

14. The fuel system of claim 13 wherein the tap is fluidly connected to an outlet of the booster pump and upstream of the main fuel pump.

15. The fuel system of claim 13 and further comprising a filter disposed upstream of the main fuel pump and downstream of the booster pump for filtering the fuel flow.

16. The fuel system of claim 13 and further comprising a restriction orifice disposed along the tap upstream of the first generator or permanent magnet machine.

17. The fuel system of claim 1, wherein the first permanent magnet machine is a permanent magnet alternator.

18. The fuel system of claim 1, wherein the firstpermanent magnet machine is a permanent magnet generator.

19. A method of cooling and lubricating engine components, said method comprising:
drawing, with a fuel pump, a fuel flow from a fuel tank through a fuel supply line;
providing the fuel flow through the fuel pump;
providing a first portion of the fuel flow to a metering valve;
providing a second portion of the fuel flow through a tap;
dividing the second portion of the fuel flow into a first stream provided to a heat exchanger and a second stream provided to a generator or permanent magnet machine;
warming the fuel supply line with the second stream of the second portion; and
returning the second portion of the fuel flow to the fuel supply line.

20. The method of claim 19 and further comprising filtering the fuel flow with a filter before the fuel flow enters the fuel pump.
